(19) United States
(12) Patent Application Publication
(10) Pub. No.: US 2014/0357428 A1
(43) Pub. Date: Dec. 4, 2014

(54) INTERACTIVE DISPLAY DEVICE FOR A VEHICLE

(71) Applicant: Emmanuel Guillot, Aussillon (FR)

(72) Inventor: Emmanuel Guillot, Aussillon (FR)

(73) Assignee: GOLFATTITUDE, AUSSILLON (FR)

(21) Appl. No.: 14/371,985

(22) PCT Filed: Jan. 16, 2012
(86) PCT No.: PCT/EP2012/050580

§ 371 Date: Aug. 1, 2014

(30) Foreign Application Priority Data
Jan. 21, 2011 (FR) 1150495

(51) Int. Cl. A63B 57/00; G06F 3/0484; B62D 33/02; G06F 17/30

(52) U.S. Cl. CPC A63B 57/00; G06F 17/3087; G06F 3/0484; B62D 33/0207
USPC 473/407

(57) ABSTRACT

An interactive display device for a golf vehicle comprises at least one display screen, image capturing device, a position and orientation determination device, and a support structure for securing same to the golf vehicle. The interactive display device also comprises a database of stationary or moving elements linked to the position and orientation parameters. A central unit for simultaneously displaying on the screen the captured images and elements from the database relating to an identical position and orientation, with an error approximate thereto of a pre-determined value. Optionally, the interactive device comprises a wireless device for remote transmission of images captured by the image capturing device and a remote controller for remotely controlling the image capturing device.

The present invention relates to the field of learning devices. It particularly concerns an interactive display device for a golf vehicle.

### SCOPE OF THE INVENTION AND PROBLEMS POSED

When learning golf, it is usual for an instructor to follow a beginner and indicate to him his position and movement errors along the course.

This method is naturally expensive in terms of instructor time.

### DISCLOSURE OF THE INVENTION

The aim of the present invention is thus an interactive display device for a four-wheeled vehicle of “golf cart” type, including:
at least one display screen,
image capturing means,
geolocating and orientation determining means,
a support structure for the dynamic display device on the vehicle, this support structure including means for suspending at least one display screen from a frame forming the upper structure of the vehicle,
a database of static or animated elements,
means for simultaneously displaying captured images and elements extracted from the database on the screen.

In a particular embodiment, these elements originating from the database relate to an identical geolocation and orientation, to within a predetermined error value.

By these means, a beginner user can be followed by the golf vehicle, see his movements recorded by a video camera, and for example immediately retransmitted on the display screen, together with images corresponding to the movement of an experienced player, previously recorded at the same place and at the same orientation.

In a variant embodiment, the elements of the database are associated with geolocation and orientation parameters.

In this case, advantageously, the elements extracted from the database relate to an identical geolocation and orientation to that of the vehicle at a given instant, to within a predetermined error value.

According to a preferred embodiment, the display screens are suspended from the support structure by way of an upper frame, joined to the vehicle by front and back stanchions, the upper frame having a tubular extension on each side extending backward beyond the back stanchions, a display screen being suspended from each of these tubular extensions.

In a particular case of implementation, the upper frame is substantially “U”-shaped, this upper frame also forming the outline of a roof.

In the case where the vehicle includes two seats for passengers and a back space for transporting golfing equipment for two golfers, the vehicle being without doors, but endowed with front protection bars supporting a windscreen, the support structure of the dynamic display device bears, on the one hand, on the front bars by way of two tubes attached to these front bars, and, on the other hand, at the back part of the two back sides of the seats by way of two vertical stanchions, the spacing of which can be adjusted according to the geometry of the vehicle to which the display device must be adapted.

Advantageously, the device also includes means for remote transmission of images acquired by the image capturing means.

This arrangement allows the user to keep a record of his progress or to analyze the acquired images after the fact.

Preferably, the device also includes means for remote control of the image capturing means.

In this way, it is possible to trigger and to stop the image capturing means at the moment desired by the user, without having to return to the golf vehicle each time.

Another aim of the invention, in a second aspect, is a method for learning golf, comprising the following steps:
601 of displacing a vehicle supporting an interactive display device as claimed in any one of claims 1 to 3 until the user/player is close to his next tee, and acquiring and storing in a memory the GPS position and the orientation of the vehicle 100
602 of placing the user/player at the tee,
603 of acquiring images during the movement of the user/player.
604 of displaying the images of the movement that has just been performed, together with recorded images of movements by the same user/player or by another player,

Advantageously, the method also includes a step:
605, upon the return of the user/player to the first tee of the course, of downloading the recorded images to another storage medium.

### BRIEF DESCRIPTION OF THE FIGURES

The following description, given solely by way of example of an embodiment of the invention, is given with reference to the appended figures, which represent:

FIG. 1: a golf vehicle of a type known to those skilled in the art, in a side view,

FIG. 2: an interactive display device in accordance with an embodiment of the invention, in an identical view to FIG. 1,

FIGS. 3 and 4: perspective views of the same device,

FIG. 5: a schematic representation of the elements forming the device,

FIG. 6: a flowchart of the steps of a method for using the dynamic display device as disclosed.

### DETAILED DESCRIPTION OF AN EMBODIMENT OF THE INVENTION

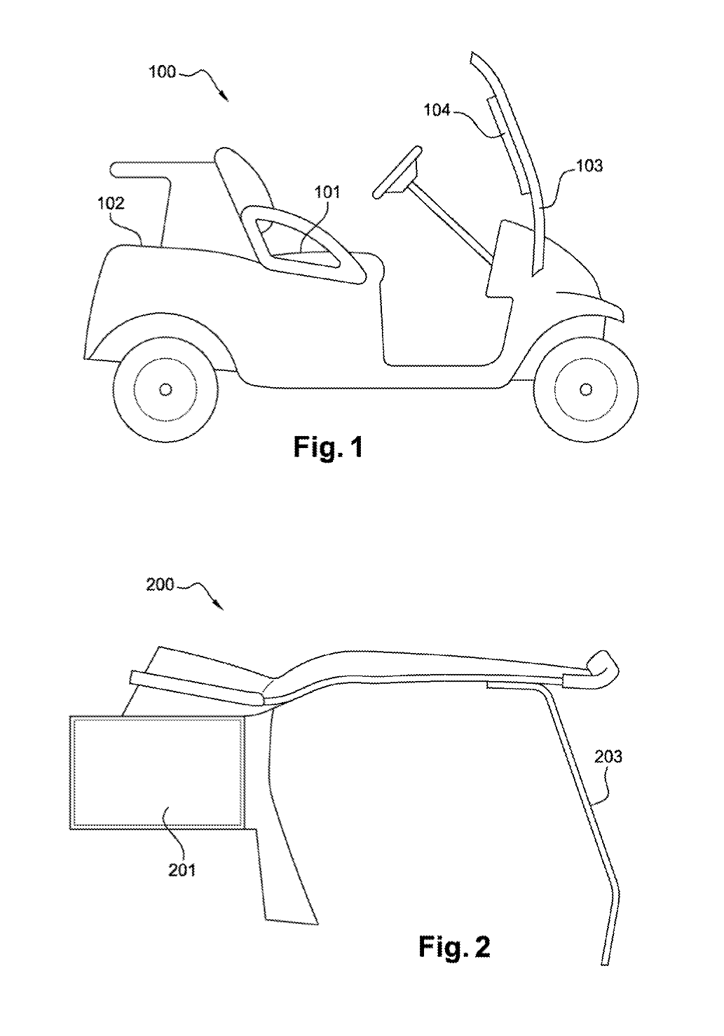

As seen in FIG. 1, in an example, in no way limiting, given here, the invention has a place on a golf vehicle of a type known per se.

Such a vehicle 100, also named “golf cart”, is usually of the four-wheeled, electrical motor type, including two seats for passengers 101 and a back space 102 for transporting golfing equipment for two golfers. In the present example, it is a vehicle without doors, but endowed with front protection bars 103 supporting a windscreen 104, and optionally a roof. Batteries powering the electric motor of the vehicle 100 are stored for example under the passenger seats 101. In the present example, it is a vehicle with a range limited to a few tens of kilometers.

FIG. 2 then illustrates the same vehicle, on which a dynamic display device 200, the subject of the invention, is installed. As configured in the present example, the dynamic display device 200 is placed above and in the back part of the vehicle 100.

It is joined thereto by way of a support structure, which here bear, on the one hand, on the front bars 103 by way of two tubes 203, and, on the other hand, at the back part of the two back sides of the seats 101 by way of two vertical stanchions 211.

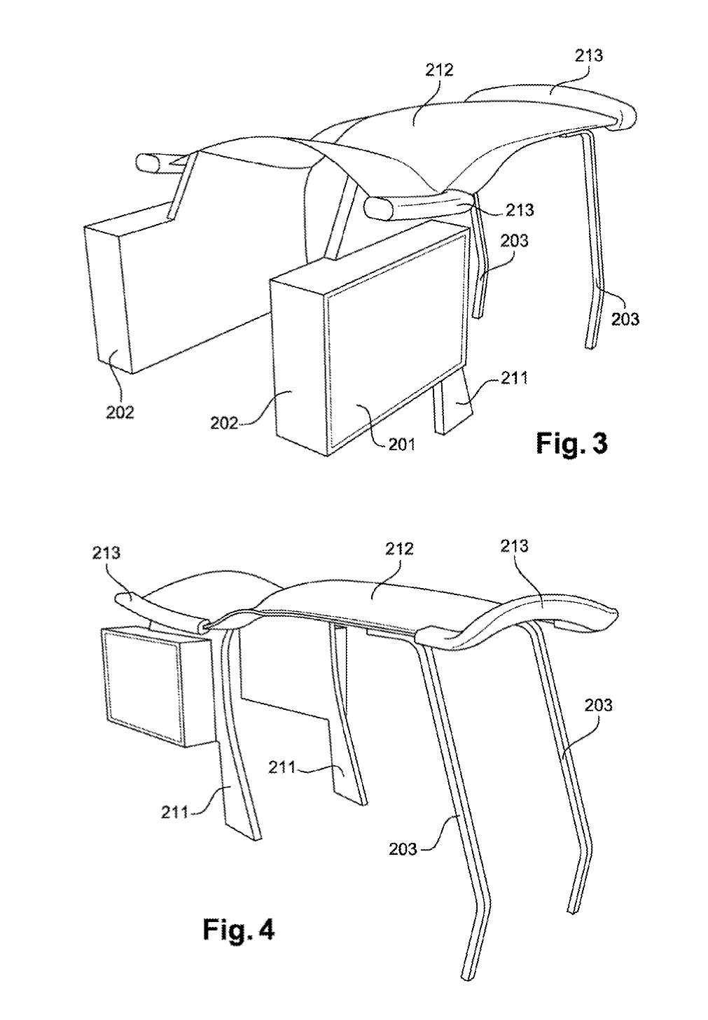

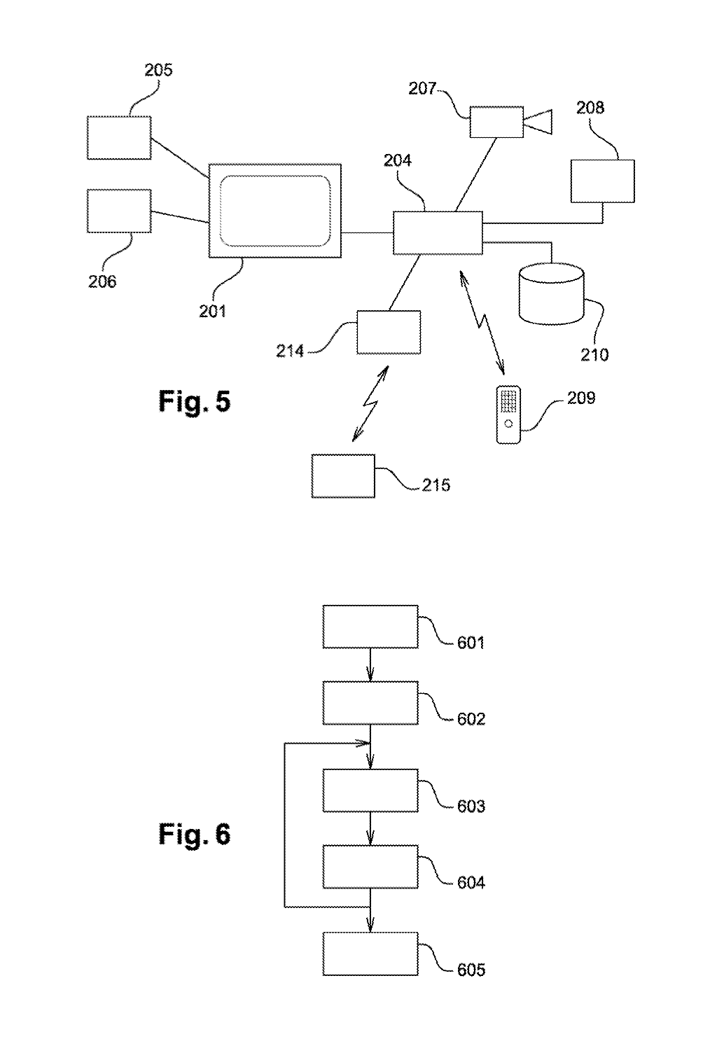

As illustrated in FIGS. 3 and 4, the dynamic display device 200 firstly includes two high-definition display screens 201, arranged laterally on either side of the back part of the vehicle. These display screens 201 are here turned outward, in such a way as to be visible by the players on the course. In the present example these are screens with a diagonal of approximately 60 centimeters, of flat-screen type. These screens are here suspended from the support structure.

In a variant implementation, the display screens 201 can be oriented about a vertical axis. In another variant, a single screen is arranged in the back part of the vehicle. In yet another variant, the vehicle includes two display screens 201, which fold back one on top of the other in the rest position.

These display screens 201 have sufficient luminosity for a correct display in full daylight. For this purpose, they use a high-luminosity display tablet, associated with an ambient luminosity sensor 205 and with control electronics 206 allowing a slaving of the luminosity of the screen to the ambient luminosity.

In the present exemplary embodiment, the display screens 201 are of touch-sensitive type, and their image source is supplied by the central unit 204 of a microcomputer of a type known per se. In another variant, the central unit 204 is merged with the control electronics 206. It is understood that the central unit 204 is controlled by the user using the touch-sensitive display screen 201.

The dynamic display device 200 secondly includes two video cameras 207, situated on either side of the vehicle, substantially in the upper inside corner of the display screens 201, and oriented toward the outside of the vehicle. Here, these video cameras 207 can be laterally and vertically oriented. They are of a type known per se, and are therefore not further detailed here. They can, for example, include functions of autofocus, zoom etc.

It is clear that in a variant, the device can include a single video camera 207, or any number of video cameras (or other image capturing means), according to the specific requirements of the application.

The dynamic display device 200 furthermore includes a geolocating means 208, for example a GPS sensor of a type known per se, adapted to determine its geographical position to the nearest few meters. It also includes a means for determining its orientation (compass). These geolocating and orienting means supply input data to the central unit 204.

The dynamic display device 200 furthermore includes a remote control 209, adapted to drive the orientation of each video camera 207, or to launch the image acquisition or its cessation.

The central unit 204 includes a data storage means, for example of hard disk type 210. The latter notably contains here a database of geolocated data composed, in the present example, of image sequences, or of static images, optionally associated with predetermined geographic positions and orientations. In an example given by way of indication, a few hundred to a few thousand image sequences, of a duration of ten or so seconds each, are stored in compressed form in the database.

This hard disk 210 also contains a software package implementing a method for using the display device 200.

In the present example, in no way limiting, the central unit also includes wireless communicating means 214 of Wi-Fi type, adapted to allow downloading of data from a central server 215 to the database or vice versa.

Each display screen 201 is here housed, together with its luminosity sensor 205, its control electronics 206 and the central unit 204 associated with it, in a casing of parallelepipedal shape 202, which optionally also houses the video camera 207 and the GPS sensor 208. In a variant embodiment, a single central unit 204 controls both the display screens 201.

This casing 202 is configured in such a way as to resist adverse weather conditions (notably humidity and rain). It optionally includes means for cooling the central unit 204.

The support structure of the dynamic display device 200 is composed, in the present example, of tubes, here metallic, arranged in such a way as to bear the mechanical load associated with the various elements forming the device. In particular, it includes the front tubes 203 and the vertical stanchions 211 already mentioned, which here support a roof 212.

The casings 202, notably housing the display screens 201, are suspended from the support structure by way of an upper frame 213, substantially “U”-shaped. This upper frame 213 bears at once on the back vertical stanchions 211 and the front bars 203, while at the same time forming the outline of the roof 212 on its side and front parts. In the present exemplary embodiment, the upper frame 213 has a tubular extension on either side extending backward beyond the vertical stanchions 211 of the vehicle. A casing 202 is suspended from each of these tubular extensions.

This choice of a suspension of the screens 201 from the frame of the roof of the vehicle, extended backward, makes it possible to create a certain flexibility in the suspension of the screens 201, and therefore to insulate said screens from the vibrations of the vehicle, thereby reducing the risks of breakage.

The dimensions of this support structure are known to those skilled in the art and will not be further detailed here. It is clear that the method of suspending the display screens 201 from the support structure is designed taking into account a need to absorb shocks potentially caused by a displacement of the vehicle over possibly rough ground.

The support structure is dimensioned according to the particular geometry of a model of golf vehicle 100, but can be made easily adaptable to many models, which have similar dimensions and layouts.

The dynamic display device 200 is intended to be installed on a golf vehicle 100 by soldering, bolting or any other fastening method.

### OPERATING MODE

When used in a golf learning aid application, the device is implemented following a method illustrated schematically in FIG. 6.

In a first step 601, the vehicle is displaced until it is close to the next tee of the user/player. The device is then activated by the player or an instructor by command on the touch-sensitive screen 201. The central unit 204 then acquires the GPS position and the orientation of the vehicle 100 and stores them in a memory.

In a second step 602, the user/player places himself at the tee, and orients the video camera 207 toward himself if it is not correctly oriented, by using the remote control 209.

In a step 603, the user/player then launches the image acquisition and performs his movement. The images acquired during this movement are stored on the hard disk 210, associated with the geolocation data of the point of acquisition of said images. Then the user/player stops the image acquisition.

In a step 604, he activates on the touch-sensitive screen 201 a function for displaying images of the movement that he has just performed, on a part of the screen 201.

In a variant implementation, in this same step 604, the central unit 204 extracts from the database images of a similar stroke, played at the same place and in a similar orientation by the same user/player or by another player, for example an instructor. The same place is understood to mean the immediate neighborhood (to within a few meters or to within a predetermined value) of this geographical position.

In another variant, the central unit extracts from the database pre-recorded images of a similar movement performed by an experienced player, not geolocated.

The central unit 204 displays, on command, the images of this pre-recorded movement, on another part of the display screen 201, in such a way as to allow easy comparison of the movements.

In another variant implementation, the central unit implements a movement analysis software package which uses the images and gleans comments on the game technique therefrom.

An instructor who is present can also comment on the images of the user/player.

The latter can perform the movement again, each time launching the recording of the images of his successive strokes. He can choose to visualize them in succession or simultaneously on various parts of the screen.

In a step 605, upon the return of the user/player to the first tee of the course, he launches the downloading of the images of the strokes that he has played to the central server 215, in such a way as to review them in the presence of an instructor, or to transfer them to a USB stick or any other data storage means.

In a variant implementation, the software package is also used to manage the score of the player.

It is understood that the invention has significant advantages:

On the one hand it forms an interactive learning means for the player, allowing him to film, analyze and correct his movements as much as he desires, by comparison with the movements of instructors.

The device also makes it possible to display data relating to the tee of the player at a given instant (difficulty etc.).

1-10. (canceled)

11. An interactive display device for a four-wheeled golf cart vehicle, comprising:
at least one display screen;
an image capturing device;
a geo-locating and orientation determining device;
a support structure for securing the interactive display device on the vehicle, the support structure comprising a device for suspending said at least one display screen from a frame forming an upper structure of the vehicle;
a database comprising static or animated elements; and
a central unit for simultaneously displaying captured images and elements extracted from the database on said at least one display screen.

12. The interactive display device as claimed in claim 11, wherein the elements of the database are associated with geo-location and orientation parameters.

13. The interactive display device as claimed in claim 12, wherein the elements extracted from the database relate to a current geo-location and orientation of the vehicle within a predetermined error value.

14. The interactive display device as claimed in claim 11, wherein two display screens are suspended from the support structure by way of an upper frame, joined to the vehicle by front and back stanchions, the upper frame having a tubular extension on each side extending backward beyond the back stanchions; and wherein a display screen is suspended from each of these tubular extensions.

15. The interactive display device as claimed in claim 14, wherein the upper frame is substantially U-shaped and forms an outline of a roof.

16. The interactive device as claimed in claim 14 configured for the vehicle comprising two seats for passengers/golfers, a back space for transporting golfing equipment for two golfers, and front protection bars supporting a windscreen, the vehicle being without doors; wherein the support structure of the interactive display device bears on the front protection bars by way of two tubes attached to the front protection bars, and on back part of two back sides of the seats by way of two vertical stanchions, the spacing of the two vertical stanchions being adjustable to accommodate the vehicle's geometry.

17. The interactive display device as claimed in claim 11, further comprising a wireless device for remote transmission of images acquired by the image capturing device.

18. The interactive display device as claimed in claim 11, further comprising a remote controller to remotely control the image capturing device.

19. A method for learning golf, comprising the steps of:
displacing a four-wheeled golf cart vehicle supporting an interactive display until a user/player is close to a tee, the interactive display comprising: at least one display screen; an image capturing device; a geo-locating and orientation determining device; a support structure for securing the interactive display device on the vehicle, the support structure comprising a device for suspending said at least one display screen from a frame forming an upper structure of the vehicle; a database comprising static or animated elements; and a central unit for simultaneously displaying captured images and elements extracted from the database on said at least one display screen;
acquiring and storing a global position system (GPS) position and an orientation of the vehicle in a memory by the geo-locating and orientation determining device in a memory;
position the user/player at the tee;
acquiring images during the user/player's movement by the image capturing device; and
displaying the images of the user/player's movement captured by the image capturing device together with previously recorded images of movements by the user/player or by another player.

20. The method as claimed in claim 19, further comprising the step of downloading recorded images to a storage medium upon a return of the user/player to a first tee of a golf course.

21. An interactive display device for a four-wheeled golf cart vehicle, comprising:
at least one display screen;
an image capturing means;
a geo-locating and orientation determining means;
a support structure for securing the interactive display device on the vehicle, the support structure comprising a device for suspending said at least one display screen from a frame forming an upper structure of the vehicle;
a database comprising static or animated elements; and
means for simultaneously displaying captured images and elements extracted from the database on said at least one display screen.
